(19) United States
(12) Patent Application Publication
(10) Pub. No.: US 2017/0217613 A1
(43) Pub. Date: Aug. 3, 2017

(54) METHOD FOR TREATING AND DISTRIBUTING FOODSTUFFS

(71) Applicants: TRITON GMBH, Berlin (DE); DEUTSCHES INSTITUT FÜR LEBENSMITTELTECHNIK E.V., Quakenbrück (DE)

(72) Inventor: Fritz Kortschack, Berlin (DE)

(21) Appl. No.: 15/500,793

(22) PCT Filed: Jul. 22, 2015
(86) PCT No.: PCT/EP2015/066705

§ 371 Date: Jan. 31, 2017

(30) Foreign Application Priority Data
Aug. 1, 2014 (DE) 10 2014 011 626.3
Oct. 1, 2014 (DE) 10 2014 014 621.9
Mar. 11, 2015 (DE) 10 2015 204 309.6

(51) Int. Cl. B65B 25/06; A23L 3/10; B65B 55/04; A23B 4/01; B65B 55/12; B65B 9/10

(52) U.S. Cl. CPC B65B 25/067; B65B 55/12; B65B 9/10; B65B 55/04; A23B 4/012; A23L 3/10; A23V 2002/00

(57) ABSTRACT

The invention relates to a method for treating and distributing foodstuffs, in particular meat or sausage products, the foodstuffs being enveloped by a packaging material or introduced into a packaging material. According to the invention, the foodstuff contained in and provided with the packaging is subjected to a targeted treatment in order to inactivate micro-organisms for the purposes of microbe reduction and a protective coating is applied to the packaging immediately afterwards or during this treatment.

The invention relates to a method for treating and distributing foodstuffs, in particular meat and sausage products, the foodstuffs being enveloped by a packaging material or introduced into a packaging material according to the preamble of patent claim 1.

It is known to use films of thermoplastic materials for the packaging of foodstuffs, wherein the films are dispensed continuously with the aid of an extruder having at least one extruder head or a multilayer head (nozzle) or as a film hose or a film web of thermoplastic material.

Films have the property of a high resistance to perforation and tear resistance. In the case of films, a distinction should be made between those films which only consist of one layer and those having a plurality of layers. In the case of films comprising a plurality of layers (co-extruded films) defined properties of different materials can be combined in one film.

Thus, coextruded films exist as packaging materials which, for example, are used in the packaging and distribution of ham. However, the production of coextruded films with an optimized layer sequence for use in the area of foodstuffs packaging is very laborious and therefore cost-intensive.

A method for the production of blown or cast films is known, for example, from DE 198 16 869 A1.

More cost-effective films can however certainly be optimized with regard to their intended application but are usually not suitable or not readily suitable for use in the foodstuffs area.

Furthermore, it is known in the production of liver sausages in natural casing to then protect the products from loss of moisture and rapid deterioration by a wax coating.

Notwithstanding the many different methods and means for packaging foodstuffs, also using plastic films, there is a need to further develop the packaging itself so that not only the corresponding foodstuff is accordingly enveloped but the formation or accumulation of microbes at or on the foodstuff or the packaging is prevented.

From the aforesaid, it is therefore the object of the invention to provide a further developed method for the treatment and distribution of foodstuffs, in particular meat or sausages, wherein the foodstuffs are surrounded by a packaging material or introduced or filled into a packaging material and inexpensive materials can be used here without any deterioration in the properties of the foodstuff or a reduction in its shelf life occurring.

The object of the invention is solved by a method according to the teaching of patent claim 1, wherein the subclaims comprise at least expedient configurations and further developments.

Accordingly, a method for the treatment and distribution of foodstuffs, in particular meat or sausages, is taken as the starting point. The foodstuffs are surrounded by a packaging material or introduced and correspondingly enveloped in a, for example, tubular packaging material.

According to the invention, the foodstuff contained in and provided with the packaging is subjected to a targeted treatment in order to inactivate micro-organisms for the purposes of microbe reduction.

Immediately afterwards or during this treatment, an outer protective layer is applied to the packaging.

From the point of view of cost reduction, the packaging material can consist of a monofilm layer or contain such a monofilm layer.

The mentioned treatment for inactivation of micro-organisms can comprise an ohmic heating, a usual (water bath, cooking cabinet, infrared irradiation etc.) thermal treatment, a treatment with high-frequency radiation, ultraviolet radiation and/or a CO₂ treatment or a combination of the afore-mentioned methods.

The protective layer(s) according to the invention can be applied by spraying, dipping, coating also assisted by electrostatic charge in parallel but successively. The respective protective layer should have such a character that the handling of the packaged product in the process of distribution is not adversely affected.

In one embodiment, the packaging material consists of a PE monohose material or flat film and the foodstuff is filled into the hose/deep-drawn cavity. Here the flexible properties of PE monohoses/films are an advantage so that very different geometries can be achieved.

In a further embodiment of the invention, before application of the protective layer, a surface treatment of the foodstuff can be carried out through the packaging material for taste and/or visual design of the same.

The protective layer can consist of a material mixture which, in addition to the actual protection of the foodstuff, is provided in addition to packaging for visual and/or haptic enhancement of the product thus suitable for distributing.

1. A method for treating and distributing foodstuffs, in particular meat and sausage products, the foodstuffs being enveloped by a packaging material or introduced into a packaging material, characterized in that the foodstuff contained in and provided with the packaging is subjected to a targeted treatment in order to inactivate micro-organisms for the purposes of microbe reduction and a protective coating is applied to the packaging immediately afterwards or during'this treatment.

2. The method according to claim 1, characterized in that the packaging material consists of at least one monofilm layer or contains such a layer.

3. The method according to claim 1, characterized in that the treatment for inactivation comprises an ohmic heating, an ozone treatment, a UV radiation treatment and/or a CO₂ treatment.

4. The method according to claim 1, characterized in that the protective layer is applied by spraying, dipping, coating or assisted by electrostatic charge.

5. The method according to claim 1, characterized in that the packaging material consists of a PE monohose material and the foodstuff is filled into the hose.

6. The method according to claim 1, characterized in that before application of the protective layer, a surface treatment of the foodstuff is carried out through the packaging material for taste and/or visual design of the same.

7. The method according to claim 1, characterized in that the protective layer consists of a material mixture which, in addition to protection of the foodstuff, is provided for visual and/or haptic enhancement of the product thus suitable for distributing.

8. The method according to claim 1, characterized in that the application of one or more protective layers is made depending on per se known technological measures in the treatment of foodstuffs either at the same time as or during the respective treatment step or following the relevant treatment step.

9. The method according to claim 1, characterized in that the treatment steps for example comprise heating, flavouring, gassing, irradiation or similar.
